(19) United States
(12) Patent Application Publication
(10) Pub. No.: US 2026/0064309 A1
(43) Pub. Date: Mar. 5, 2026

(54) STORAGE SYSTEM, MAP GENERATION DEVICE, AND MAP GENERATION METHOD

(71) Applicant: Hitachi Vantara, Ltd., Yokohama-shi, Kanagawa-ken (JP)

(72) Inventors: Takumi OISHI, Tokyo (JP); Eiju KATSURAGI, Yokohama-shi (JP)

(73) Assignee: Hitachi Vantara, Ltd., Yokohama-shi, Kanagawa-ken (JP)

(21) Appl. No.: 19/069,379

(22) Filed: Mar. 4, 2025

(30) Foreign Application Priority Data
Aug. 29, 2024 (JP) 2024-147664

(51) Int. Cl. G06F 3/06

(52) U.S. Cl. CPC G06F 3/0655; G06F 3/0673; G06F 3/0679

(57) ABSTRACT

A storage system manages parcels of a parcel group including parcels of user data and redundant data, and includes a storage device that stores an integrated map including showing a correspondence relation between a parcel and a drive. A first map corresponding to a first count for which the number of drives in each drive box is the same has a failure resistance correspondence relation having failure resistance by which the user data is not lost even if a failure occurs in the drive boxes of a predetermined number or less. The first map is configured to have a relation that is implemented by moving data of one parcel to a drive box in which a drive is added, from a storage state of the parcel in the drive according to a second map corresponding to a count of the drive less than the first drive by one.

### BACKGROUND OF THE INVENTION

### 1. Field of the Invention

The present invention relates to a map showing a correspondence relation between a parcel including data and a drive storing the parcel in a storage system having a plurality of drive boxes accommodating drives.

### 2. Description of Related Art

In recent years, a solid state drive (SSD) is mainly used in a storage device, and a capacity thereof has been increasing, for example, to 30 terabytes (TB). As the capacity of a drive increases, the following two problems become apparent.

The first problem is that the recovery processing time at the time of drive failure is prolonged. In order to prevent data loss due to a drive failure, a storage device has a redundant array of independent (or inexpensive) disks (RAID) function, and executes processing of recovering data stored in a failed drive by the RAID function. Since the time required for the processing is proportional to the drive capacity, the time is prolonged due to the increase in capacity. If a drive failure occurs again during the recovery processing, the probability of data loss increases, and thus a reduction in recovery processing time is required.

The second problem is that the investment efficiency decreases. When the RAID function is enabled, it is necessary to add the drive in increments of several RAID stripe widths. The stripe width is determined by the number of pieces of user data and the number of pieces of redundant data, and typically uses 4 or 8. For example, in a case of a drive having a stripe width of 8 and a capacity of 30 TB, the drive is added in increments of eight, and the capacity needs to be added in increments of 240 TB. That is, for example, even when it is desired to add a capacity of 50 TB, it is necessary to add 240 TB, and it is necessary to purchase the drives in a number having a capacity equal to or larger than the required capacity.

In order to solve the above two problems, a distributed RAID technology disclosed in NPL 1 has attracted attention. In the RAID in the related art, a RAID group is implemented by drives in the number equal to a stripe width and stores data. On the other hand, in the distributed RAID, a RAID group can be implemented with any number of drives, and data can be distributed and stored in more drives. Regarding the recovery processing at the time of a drive failure, although the processing is concentrated on a small number of drives in the RAID in the related art, the recovery processing time can be reduced since distributed processing can be performed in a large number of drives in the distributed RAID. In a case where it is necessary to add the capacity, it is possible to add the drive in increments of one, and thus the investment efficiency is very high.

Some storage systems include a drive box that accommodates a plurality of drives. Some of such storage systems have a RAID function for preventing data loss due to a drive failure and a drive box failure resistance function for preventing data loss due to a drive box failure. For example, a technique including a drive box failure resistance function in a distributed RAID is disclosed in, for example, PTL 1.

### CITATION LIST

### Patent Literature

PTL 1: JP2022-175427A

### Non Patent Literature

NPL 1: Non-standard RAID levels, Internet (URL: https://en.wikipedia.org/wiki/Non-standard_RAID_levels #Declustered_RAID)

### SUMMARY OF THE INVENTION

For example, in the technique disclosed in PTL 1, in order to enable the drive box failure resistance function, it is a precondition that the number of drives is the same in all drive boxes. Therefore, when using the drive box failure resistance function, it is not possible to add the drive in increments of one. On the other hand, in a storage system, when using a function of adding the drive in increments of one, it is not guaranteed that the number of drives is the same in all drive boxes, and thus the drive box failure resistance function cannot be used. For this reason, a user needs to select one of the functions to implement the distributed RAID in the storage system.

In the storage system, once the distributed RAID is implemented, it is not possible to change to the configuration in which the drive can be added in increments of one from the configuration in which the drive box failure resistance function is enabled, and it is not possible to change to the configuration in which the drive box failure resistance function is enabled from the configuration in which the drive can be added in increments of one, unless the configuration of the distributed RAID is deleted, for the above reason. For example, since backup is easy while the data capacity is small, data loss due to a drive box failure is allowed and the drive can be added in increments of one with emphasis on investment efficiency, and when the data capacity is large, flexible use of changing the drive box failure resistance function to “enabled” with emphasis on data loss countermeasures is difficult.

For example, as a procedure for making it possible to change the storage system from a configuration in which the drive can be added in increments of one to a configuration in which the drive box failure resistance function can be enabled, there is a procedure in which all data is backed up once to delete the distributed RAID configuration, the drive box failure resistance function is enabled to recreate the distributed RAID configuration, and the backed-up data is stored in the recreated distributed RAID. This procedure is complicated, and a long time of work is required.

The invention has been made in view of the above circumstances, and an object thereof is to provide a technique capable of easily and quickly adding the drive in increments of one in a storage system and enabling a drive box failure resistance function when a predetermined drive count is set.

In order to achieve the above object, a storage system according to an aspect includes a plurality of drive boxes each accommodating one or more drives. The storage system manages a plurality of parcel groups, each of which includes a parcel including user data and a parcel including redundant data for restoring the user data, in a distributed manner such that parcels included in a same parcel group are not arranged in a same drive. The storage system includes a storage device that stores a map group including a map showing a correspondence relation between each parcel and a drive storing the parcel, the map group corresponding to a respective count within a predetermined count range of the drive that is able to be installed in the storage system. A first map corresponding to a first count in a case where the number of drives accommodated in the plurality of drive boxes is same has a drive box failure resistance correspondence relation that is a correspondence relation between the parcel and the drive storing the parcel, the drive box failure resistance correspondence relation having drive box failure resistance by which the user data is not lost even if a failure occurs in drive boxes of a predetermined number or less. The first map has a correspondence relation that is able to be implemented by moving data of one parcel in certain parcel groups to a drive box in which a drive is added, from a storage state of the parcel in the drive according to a correspondence relation between the parcel and the drive in a second map corresponding to a second count of the drive less than the first count by one.

According to the invention, when the drive is increased by one and the number of drives accommodated in each of a plurality of drive boxes is the same, it is possible to easily and quickly specify a correspondence relation between a parcel and a drive storing the parcel, the correspondence relation having drive box failure resistance. Problems, configurations, and effects other than those described above will become apparent in the following description of an embodiment of the invention.

### BRIEF DESCRIPTION OF THE DRAWINGS

FIG. 1 is an overall configuration diagram illustrating a computer system according to an embodiment;

FIG. 2 is a diagram illustrating mapping of parcels according to an embodiment;

FIG. 3 is a configuration diagram of an integrated map according to an embodiment;

FIG. 4 is a configuration diagram of a drive addition and reduction operation screen according to an embodiment;

FIG. 5 is a configuration diagram of a state transition table according to an embodiment;

FIG. 6 is a configuration diagram of a transition permission list according to an embodiment;

FIG. 7 is a diagram illustrating a change in mapping at the time of drive addition according to an embodiment;

FIG. 8 is a flowchart of integrated map generation processing according to an embodiment; and

FIG. 9 is a flowchart of state transition processing according to an embodiment.

### DESCRIPTION OF EMBODIMENTS

Hereinafter, an embodiment according to the invention will be described with reference to the drawings. The embodiment is an example for describing the invention, and is omitted and simplified as appropriate for clarity of description. The invention can be implemented in various other forms. Unless otherwise specified, each component may be single or plural.

In order to facilitate understanding of the invention, the position, size, shape, range, and the like of each component illustrated in the drawings may not represent an actual position, size, shape, range, or the like. Therefore, the invention is not necessarily limited to the position, size, shape, range, or the like disclosed in the drawings.

As examples of various types of information, expressions such as “table”, “list”, and “queue” may be used for description, and the various types of information may be expressed in other data structures. For example, various types of information such as “AA table”, “AA list”, and “AA queue” may be “AA information”.

In describing identification information, when expressions such as “identification information”, “identifier”, “name”, “ID”, and “number” are used, the expressions can be replaced with one another.

When there are a plurality of components having the same or similar functions, the plurality of components may be denoted by the same reference numerals assigned with different subscripts. When it is not necessary to distinguish the plurality of components, the description may be made by omitting the subscripts.

In the embodiment, processing may be described with a “program” as an operation subject, and since the program is executed by a processor to perform determined processing using at least one of a storage unit and an interface unit as appropriate, the subject of the processing may be the processor (or a computer or a computer system including the processor). The program may be installed on the computer from a program source. The program source may be, for example, a program distribution server or a computer-readable recording medium. In the following description, two or more programs may be implemented as one program, or one program may be implemented as two or more programs. Further, at least a part of the processing implemented by executing the program may be implemented by a hardware circuit (for example, an application specific integrated circuit (ASIC) or a field-programmable gate array (FPGA)).

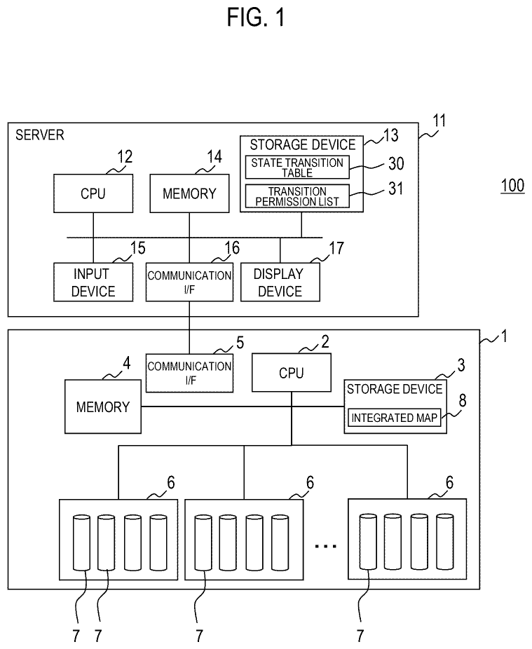

FIG. 1 is an overall configuration diagram illustrating a computer system according to an embodiment.

A computer system 100 includes a server 11 and a storage system 1. The storage system 1 manages data (user data) to be used by the server 11 for processing. The server 11 performs various types of processing by writing data to the storage system 1 and reading data from the storage system 1. In the embodiment, the server 11 is an example of a map generation device, and performs processing of generating an integrated map 8 of the storage system 1.

The server 11 is, for example, a computer such as a personal computer (PC) or a general-purpose server, and includes a central processing unit (CPU) 12, a storage device 13, a memory 14, an input device 15, a communication interface (I/F) 16, and a display device 17.

The communication I/F 16 is, for example, an interface such as a wired LAN card or a wireless LAN card, and communicates with the storage system 1.

The CPU 12 is an example of a processor, and executes various types of processing according to a program stored in the memory 14 and/or the storage device 13. In the embodiment, the CPU 12 writes data used for processing to the storage system 1 and reads data from the storage system 1.

The memory 14 is, for example, a random access memory (RAM), and stores programs to be executed by the CPU 12 and necessary information.

The storage device 13 is, for example, a hard disk or a flash memory, and stores programs to be executed by the CPU 12 and data used by the CPU 12. In the embodiment, the storage device 13 stores a state transition table 30 and a transition permission list 31. Details of the state transition table 30 and the transition permission list 31 will be described later.

The input device 15 is, for example, a mouse or a keyboard, and receives input of information by a user. The display device 17 is, for example, a display, and displays and outputs a user interface including various types of information.

The storage system 1 includes a CPU 2, a storage device 3, a memory 4, a communication I/F 5, and a plurality of drive boxes 6.

The communication I/F 5 is, for example, an interface such as a wired LAN card or a wireless LAN card, and communicates with the server 11.

The drive box 6 can accommodate one or more drives 7 and has a function of supplying power to the drives 7. The drive 7 is, for example, a hard disk or a flash memory, and stores a parcel including user data and a parcel including redundant data for restoring the user data.

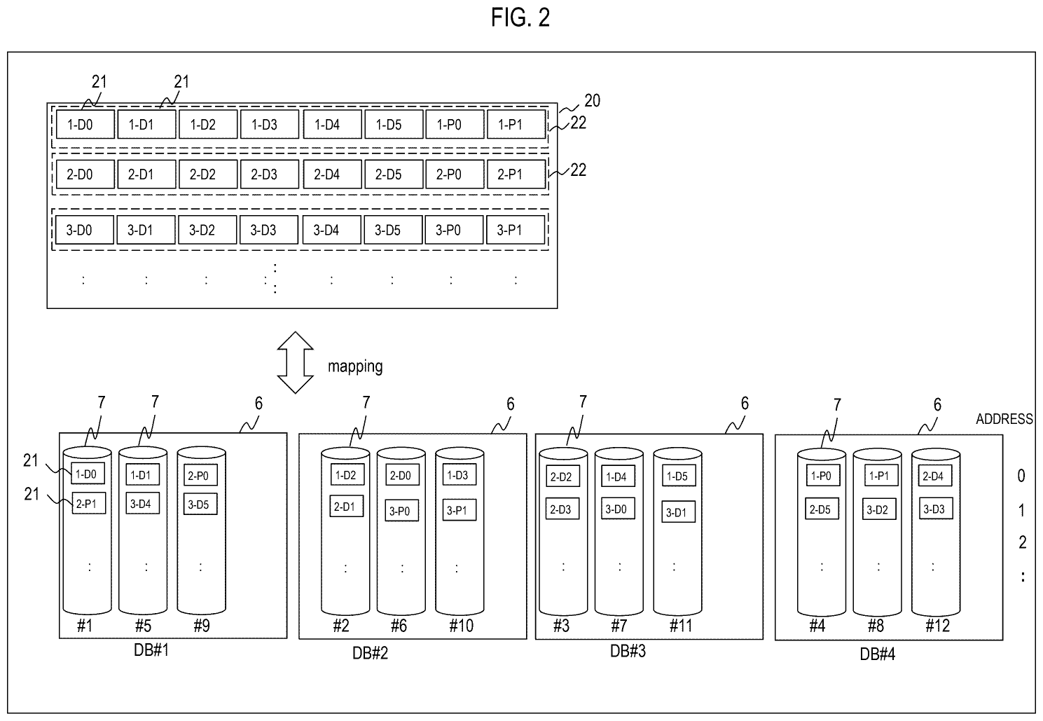

The CPU 2 is an example of a processor, and executes various types of processing according to a program stored in the memory 4 and/or the storage device 3. In the embodiment, the CPU 2 executes data read processing and data write processing in accordance with a user data read request and a user data write request from the server 11. In the embodiment, the CPU 2 has a distributed RAID function of creating a parcel group including a parcel including user data and a parcel including redundant data for restoring the user data, managing the parcel group on a virtual storage area 20 (see FIG. 2), and distributing and managing parcels of the same parcel group to a plurality of drives 7. As a configuration handled by the distributed RAID function, for example, a 3D (data) 1P (parity) configuration in which three parcels of user data and one parcel of redundant data are included in a parcel group may be adopted, a 6D2P configuration in which six parcels of user data and two parcels of redundant data are included in a parcel group may be adopted, or another configuration may be adopted. The CPU 2 specifies a storage position of each parcel in the virtual storage area 20 with reference to the integrated map 8 described later. In a case where one drive 7 is added, the CPU 2 refers to the integrated map 8, refers to a map corresponding to the total count of drives in a case where the drive is added, and adjusts (moves) the position of the parcel so as to be an arrangement corresponding to the map.

The memory 4 is, for example, a RAM, and stores programs to be executed by the CPU 2 and necessary information. The storage device 3 is, for example, a hard disk or a flash memory, and stores programs to be executed by the CPU 2 and data used by the CPU 2. In the embodiment, the storage device 3 stores the integrated map having a plurality of maps indicating a correspondence relation between parcels and storage positions where the parcels are stored.

The integrated map 8 includes a map corresponding to each count in a predetermined count range of the drive 7 that can be installed in the storage system 1 (for example, from a minimum count to a maximum count in the storage system 1), and each map indicates a correspondence relation between parcels and arrangement positions (information on drives, for example, drive numbers and chunk numbers) where the parcels are arranged. The integrated map 8 includes, for example, a plurality of maps for each configuration when a plurality of configurations such as 3D1P and 6D2P can be set as the configuration of the RAID in the storage system 1.

In the integrated map 8, a map (first map) corresponding to a count, which is the same number of drives 7 disposed in each drive box 6 (a first count: for example, 8, 12, 16 . . . in a case where the RAID configuration is 6D2P), has a drive box failure resistance correspondence relation that is a correspondence relation between the parcel and the drive storing the parcel, the drive box failure resistance correspondence relation having drive box failure resistance by which the user data is not lost even if a failure occurs in drive boxes of a predetermined number or less (one in the case of 6D2P). The first map has a correspondence relation that can be implemented by moving data of one parcel in some parcel groups to a drive box in which a drive is added, from a storage state of the parcel in the drive 7 according to a correspondence relation between the parcel and the drive in a map (second map) corresponding to a count (second count) less than the count, which is the same number of drives 7 in the drive box 6, by one. A method of generating the integrated map 8 will be described later.

Here, for example, in the storage system in the related art, in order to realize the addition of the drive 7 in increments of one, it is necessary to prepare a one-increment addition map for managing the correspondence relation between the parcel and the drive for each count, and in order to enable the drive box failure resistance, it is necessary to prepare a drive box failure resistance map for managing the correspondence relation between the parcel and the drive for each count that is a count at which the drive box failure resistance can be realized. Here, since the one-increment addition map and the drive box failure resistance map are created independently of each other, the correspondence relation between the parcels and the drives in the one-increment addition map and the correspondence relation between the parcels and the drives in the drive box failure resistance map are completely different for a case where the total count of drives is the same. On the other hand, in the integrated map 8, since the map corresponding to the count, which is the same number of drives 7 in the drive box 6, is generated so as to have a correspondence relation satisfying the drive box failure resistance, the necessity of storing the one-increment addition map and the drive box failure resistance map for the same number of drives as in the related art is eliminated, and it is possible to reduce the capacity necessary for storing the map.

FIG. 2 is a diagram illustrating mapping of parcels according to an embodiment. FIG. 2 illustrates an example of the 6D2P configuration.

The storage system 1 manages data in the virtual storage area 20. In the virtual storage area 20, data is managed in units of parcels 21 having a predetermined fixed length.

In the 6D2P configuration, eight parcels including 6 parcels 21 that store user data and 2 parcels 21 that store redundant data (parity data) for restoring the user data are set as a parcel group 22. Here, the parcel can be said to be a stripe in RAID, and the stripe width can be said to be 8.

A first numeral in an ID (parcel ID) assigned to the parcel 21 in FIG. 2 indicates a parcel group number, D indicates user data, P indicates redundant data, and a numeral following D or P indicates the number of the user data or the redundant data in the parcel group. For example, 1-DO indicates zeroth user data in a first parcel group, and 3-P1 indicates first redundant data in a third parcel group.

The parcel 21 in the virtual storage area 20 is mapped and stored in any of a plurality of drives 7. In the embodiment, mapping between parcels and storage positions of the parcels is managed by the integrated map 8. In the embodiment, the drives 7 are arranged in order from the drive box 6 having the smallest number such that the number of drives 7 accommodated in each drive box 6 is as uniform as possible, and the drives 7 are assigned with numbers according to the arrangement order.

In the example in FIG. 2, for example, the parcel 21 of 1-D1 is stored at address 0 of the drive 7 of #5,and the parcel 21 of 1-D4 is stored at address 0 of the drive 7 of #7.

Next, a configuration of the integrated map 8 that manages the mapping of the parcels illustrated in FIG. 2 will be described.

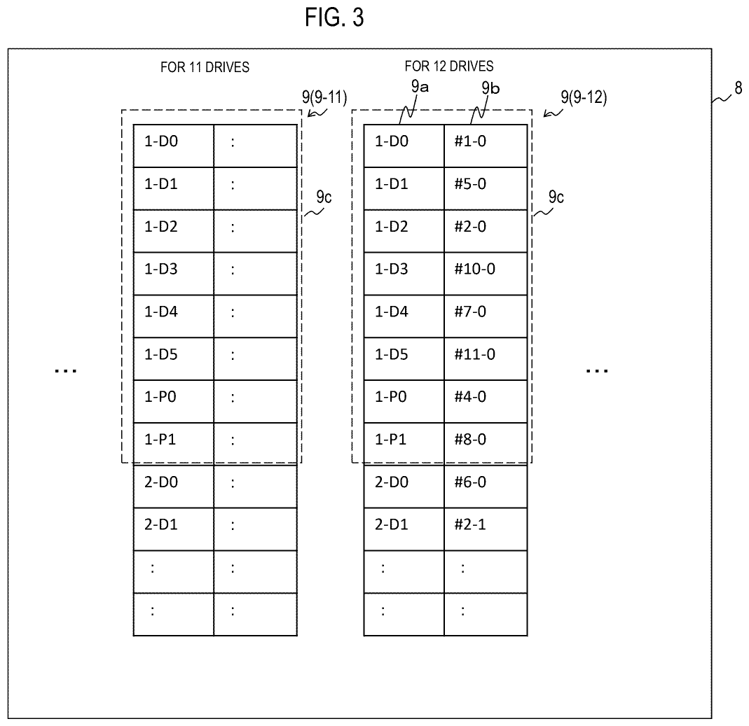

FIG. 3 is a configuration diagram of an integrated map according to an embodiment. The integrated map 8 in FIG. 3 is an integrated map corresponding to the 6D2P configuration.

The integrated map 8 is a map group including maps 9 ( . . . , 9-11, 9-12, . . . ) indicating a correspondence relation for each count of the counts in a predetermined range assumed to be used in the storage system 1. The map 9-12 corresponds to the state in FIG. 2.

The map 9 (9-11, 9-12) includes an entry for each parcel. The entry includes fields of a parcel 9a and a storage position 9b. The parcel ID of the parcel 21 is stored in the parcel 9a. The storage position 9b stores information (drive number and address) on the drive in which the parcel 21 of the parcel ID corresponding to the entry is stored. For example, #2-0 indicates storage at address 0 of the drive 7 of #2. As illustrated in FIG. 3, parcels in a same parcel group 9c are distributed and stored in different drives 7.

Next, writing and reading of data using the map 9 in the integrated map 8 will be described.

When storing data in the storage system 1, the CPU 2 refers to the virtual storage area 20, searches for a free area in which no data is stored, divides the data to be stored into the size of a parcel group, and sequentially arranges each parcel in the free area. Next, the CPU 2 refers to the map 9 corresponding to the total count of drives 7 of the storage system 1, and writes the data of the parcel arranged in the free area to a corresponding address of the drive 7 of the corresponding drive number. On the other hand, when reading data, the CPU 2 searches the parcel of the data to be read in the virtual storage area 20, acquires the drive number and the address corresponding to the parcel with reference to the map 9, and reads the data of the parcel from the acquired address of the drive 7 having the acquired drive number.

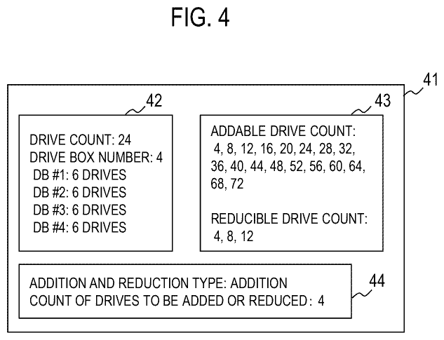

FIG. 4 is a configuration diagram of a drive addition and reduction operation screen according to an embodiment.

A drive addition and reduction operation screen 41 is a screen (proposal screen) displayed on the display device 17 of the server 11 by the CPU 2 of the storage system 1 when a drive addition and reduction request is transmitted from the server 11 to the storage system 1.

The drive addition and reduction operation screen 41 includes a current drive count display area 42, an operable drive count display area 43, and an operation instruction input area 44.

In the current drive count display area 42, information on the drives 7 currently held by the storage system 1 is displayed. In the example in FIG. 4, the count of the drives 7, the number of drive boxes 6, and the count of the drives 7 accommodated in each drive box 6 are displayed in the current drive count display area 42.

In the operable drive count display area 43, the count of drives that can be selected to change (add or reduce) from the current count of drives to the count of drives that can enable a drive box failure resistance function is displayed.

The operation instruction input area 44 is an area for an administrator to input an instruction to add or reduce a drive. In the operation instruction input area 44, an addition and reduction type indicating whether to add or reduce the drive, and the count of drives to be added or reduced can be input. For example, by selecting one from drive counts displayed in the operable drive count display area 43 and inputting the one to the operation instruction input area 44, it is possible to easily perform an instruction to enable the drive box failure resistance function. By inputting a drive count, which is not displayed in the operable drive count display area 43, to the operation instruction input area 44, it is possible to easily add or reduce the input count of drives.

Next, the state transition table 30 will be described.

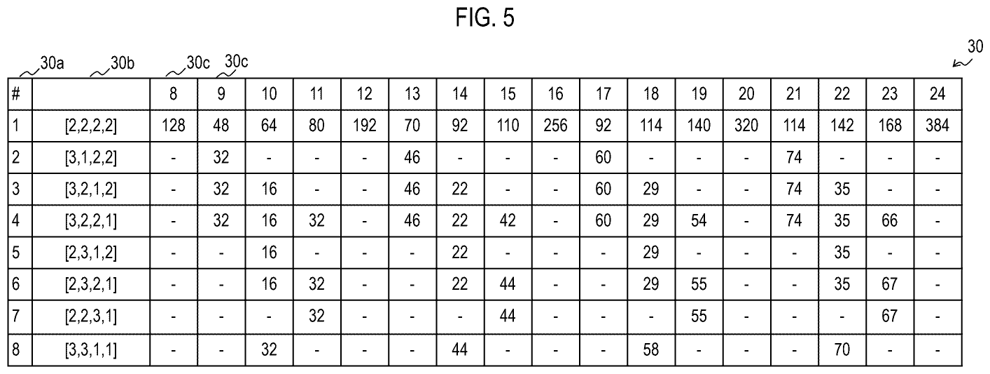

FIG. 5 is a configuration diagram of a state transition table according to an embodiment.

The state transition table 30 in FIG. 5 corresponds to the 6D2P RAID configuration, and is an example in which there are four drive boxes 6, one parcel group has eight parcels, and the number of parcel groups that can be stored in one drive 7 is 16. The state transition table 30 represents an arrangement pattern in which the parcel group is changed in a case where the total count of drives 7 is increased one by one. The state transition table 30 includes an entry for each arrangement pattern indicating the drive box 6 in which each parcel in the parcel group is arranged (stored). The entry of the state transition table 30 includes fields of a pattern number 30a, an arrangement pattern 30b, and a plurality of drive counts 30c.

The pattern number 30a stores a number indicating an arrangement pattern corresponding to the entry. The arrangement pattern 30b stores an arrangement pattern indicating a drive box in which each parcel in the parcel group is arranged. The arrangement pattern is indicated by [A, B, C, D]. A, B, C, and D are numbers from 0 to 8, and the total of A+B+C+D is 8.

Here, A indicates the number of parcels stored in the drive box 6 of #1, B indicates the number of parcels stored in the drive box 6 of #2, C indicates the number of parcels stored in the drive box 6 of #3, and D indicates the number of parcels stored in the drive box 6 of #4. For example, [2, 2, 2, 2] indicates an arrangement pattern in which two parcels in one parcel group are stored in the drive box 6 of #1, two parcels are stored in the drive box 6 of #2, two parcels are stored in the drive box 6 of #3, and two parcels are stored in the drive box 6 of #4. The arrangement pattern [2, 2, 2, 2] is a pattern in which each parcel can be restored even when a failure occurs in any of the drive boxes 6, that is, a pattern having drive box failure resistance. In the embodiment, in FIG. 5, the arrangement pattern is limited to only eight arrangement patterns among patterns that can be taken as arrangement patterns.

The plurality of drive counts 30c are associated with the total counts of drives in a predetermined range (for example, from a minimum count of the drives to a maximum count of the drives) installed in the storage system 1, respectively. In the example in FIG. 5, the drive count 30c is provided correspondingly to each of the drive counts from 8 to 24. In a case of the corresponding total count of drives, the number of parcel groups to be stored as an arrangement pattern corresponding to an entry is stored in the drive count 30c. When there is no parcel group of the arrangement pattern corresponding to the entry, the drive count 30c stores “-” indicating “absence”.

For example, when the total count of drives is 8, the number of parcel groups corresponding to the arrangement pattern #1 ([2, 2, 2, 2]) is indicated to be 128. When the total count of drives is 9, the number of parcel groups corresponding to the arrangement pattern #1 is 48, the number of parcel groups corresponding to the arrangement pattern #2 ([3, 1, 2, 2]) is 32, the number of parcel groups corresponding to the arrangement pattern #3 ([3, 2, 1, 2]) is 32, and the number of parcel groups corresponding to the arrangement pattern #4 ([3, 2, 2, 1]) is 32.

In this example, in a case where the count of drives 7 in each drive box 6 is the same, that is, in a case where the total counts of drives are multiples of 4 such as 8, 12, . . . , the arrangement pattern of all the parcel groups is determined to be [2, 2, 2, 2], and thus the drive box failure resistance function is determined to be enabled.

For example, a case where the total count of drives is increased by one from 11 to 12 will be described. When the total count of drives is 11, the number of parcel groups corresponding to the arrangement pattern #1 is 80, the number of parcel groups corresponding to the arrangement pattern #4 ([3, 2, 2, 1]) is 32, the number of parcel groups corresponding to the arrangement pattern #6 ([2, 3, 2, 1]) is 32, and the number of parcel groups corresponding to the arrangement pattern #7 ([2, 2, 3, 1]) is 32. Here, the arrangement pattern #1 is a second arrangement pattern, and the arrangement patterns #4, #6, and #7 are first arrangement patterns.

Here, when one drive 7 is added to the drive box #4 and the total count of drives is 12, the total number of parcel groups is 192. In this case, for each of the 32 parcel groups corresponding to the arrangement pattern #4, one parcel is moved from the drive box #1 to the drive box #4 to form the arrangement pattern #1, and similarly, for each of the 32 parcel groups corresponding to the arrangement pattern #6, one parcel is moved from the drive box #2 to the drive box #4 to form the arrangement pattern #1, and for each of the 32 parcel groups corresponding to the arrangement pattern #7, one parcel is moved from the drive box #3 to the drive box #4 to form the arrangement pattern #1, and 16 parcel groups corresponding to the added capacity are set as the arrangement pattern #1.

Accordingly, all of the 192 parcel groups can be set as the arrangement pattern #1. That is, the drive box failure resistance function can be enabled in the storage system 1. Further, in this case, for some parcel groups, that is, the parcel groups corresponding to the arrangement patterns #4, #6, and #7, only data of one parcel may be moved to be stored in the drive box #4 to which the drive 7 is added, and the amount of data to be transmitted can be reduced.

Here, the state transition table 30 is used to generate a map corresponding to each count as described later, and since the number of arrangement patterns when eight parcels in each parcel group are distributed and stored can be limited to a small number (eight in this example), the amount of calculation and the calculation time for generating the map can be reduced.

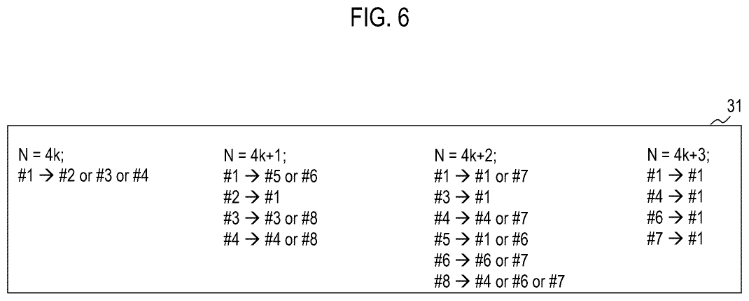

FIG. 6 is a configuration diagram of a transition permission list according to an embodiment. The transition permission list 31 in FIG. 6 is a list showing arrangement patterns to which transition can be made when the count of drives in the state transition table 30 illustrated in FIG. 5 is increased by one.

In the transition permission list 31, N represents the total count of drives, and k represents a natural number of 2 or more. In a case where N=4k, that is, the total count of drives is a multiple of 4, when one drive 7 is added, the parcel group of the arrangement pattern #1 can transition to any of the arrangement patterns #2, #3, and #4. In a case where N=4k+1, that is, the total count of drives is a multiple of 4+1, when one drive 7 is added, the parcel group of the arrangement pattern #1 can transition to any one of the arrangement patterns #5 and #6, the parcel group of the arrangement pattern #2 can transition to the arrangement pattern #1, the parcel group of the arrangement pattern #3 can transition to any one of the arrangement patterns #3 and #8, and the parcel group of the arrangement pattern #4 can transition to any one of the arrangement patterns #4 and #8.

In a case where N=4k+2, that is, the total count of drives is a multiple of 4+2, when one drive 7 is added, the parcel group of the arrangement pattern #1 can transition to any one of the arrangement patterns #1 and #7, the parcel group of the arrangement pattern #3 can transition to the arrangement pattern #1, the parcel group of the arrangement pattern #4 can transition to any one of the arrangement patterns #4 and #7, the parcel group of the arrangement pattern #5 can transition to any one of the arrangement patterns #1 and #6, the parcel group of the arrangement pattern #6 can transition to any one of the arrangement patterns #6 and #7, and the parcel group of the arrangement pattern #8 can transition to any one of the arrangement patterns #4, #6, and #7. Further, in a case where N=4k+3, that is, the total count of drives is a multiple of 4+3, when one drive 7 is added, the parcel group of the arrangement pattern #1 can transition to the arrangement pattern #1, the parcel group of the arrangement pattern #4 can transition to the arrangement pattern #1, the parcel group of the arrangement pattern #6 can transition to the arrangement pattern #1, and the parcel group of the arrangement pattern #7 can transition to the arrangement pattern #1.

Next, a change in mapping at the time of drive addition will be described.

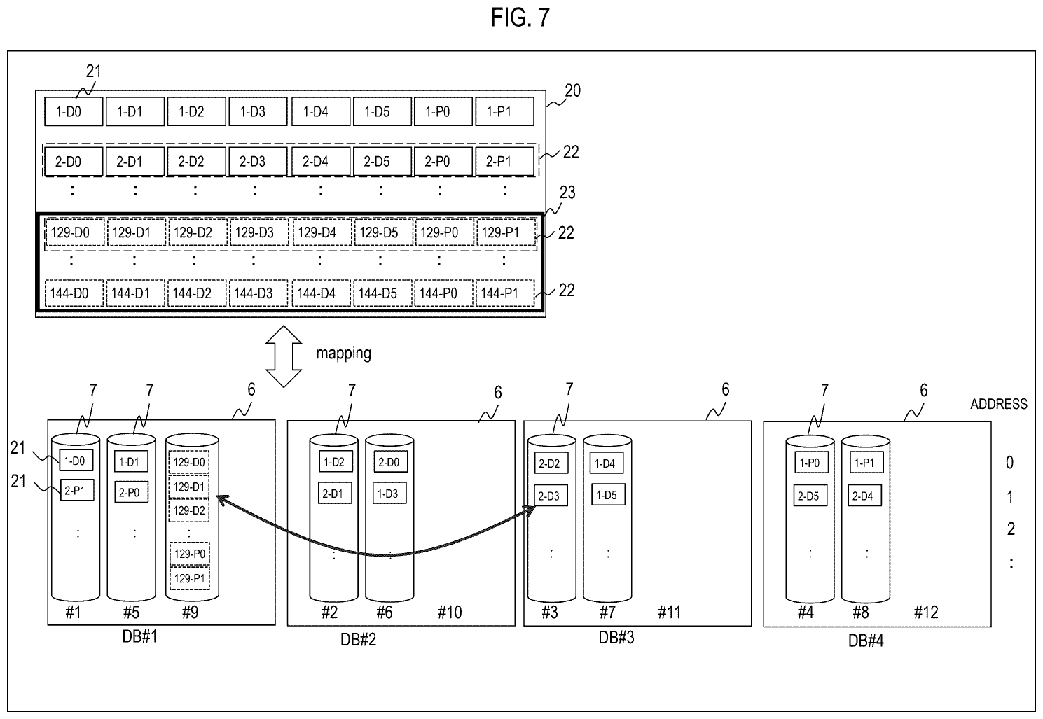

FIG. 7 is a diagram illustrating a change in mapping at the time of drive addition according to the embodiment. FIG. 7 illustrates a state of a change in mapping in a case where the total count of drives is changed from 8 to 9 by adding the drive 7 of #9.

When the drive 7 of #9 is added, an area of a parcel group set 23 including 16 parcel groups 22 corresponding to the capacity of the added drive 7 is added in the virtual storage area 20.

In this example, the numbers of the new parcel group 22 that is added as the parcel group set 23 are 129 to 144. First, the parcels 21 of each parcel group 22 of the parcel group set 23 are stored in the drive #9. In FIG. 7, for convenience, only the parcels of the parcel group No. 129 are displayed.

In this state, since all the parcels 21 of the new parcel groups 22 are present in the added drive #9, if the added drive #9 fails in this state, data cannot be accessed. In order to prevent such a situation, seven parcels 21 of the eight parcels 21 in each parcel group are moved to different drives 7.

Here, since there is no space in the existing drive

7, the existing parcel 21 is replaced. That is, processing of replacing the seven parcels 21 with the existing parcels 21 stored in different drives 7 is performed for each of the new parcel groups 22. The processing of replacing the new parcel with the existing parcel is performed with reference to the map 9 for eight drives. Specifically, as the map 9 for nine drives, a map having the same contents as those of the map 9 for eight drives is prepared, and in this map, a new parcel and an existing parcel are replaced with each other, so that a part for which the replacement is completed has contents corresponding to the map 9 for nine drives, and the map 9 for nine drives is completed by completing all the replacement.

Therefore, the map 9 for nine drives may be generated so as to be in a state after the processing of replacing the seven parcels 21 with the existing parcels 21 stored in different drives is performed. Similarly, it is possible to generate a map corresponding to any drive count by sequentially generating the map 9 while adding the drive one by one. However, when generating the map 9 in this way, it is necessary to create an initial map, that is, a map corresponding to the minimum total count of drives in advance. In the embodiment, since the minimum count of drives is eight, the map for storing the parcel may be created for all the parcel groups from the drive #1 to the drive #8 one by one.

Next, integrated map generation processing of generating the integrated map 8 by the server 11 will be described in detail.

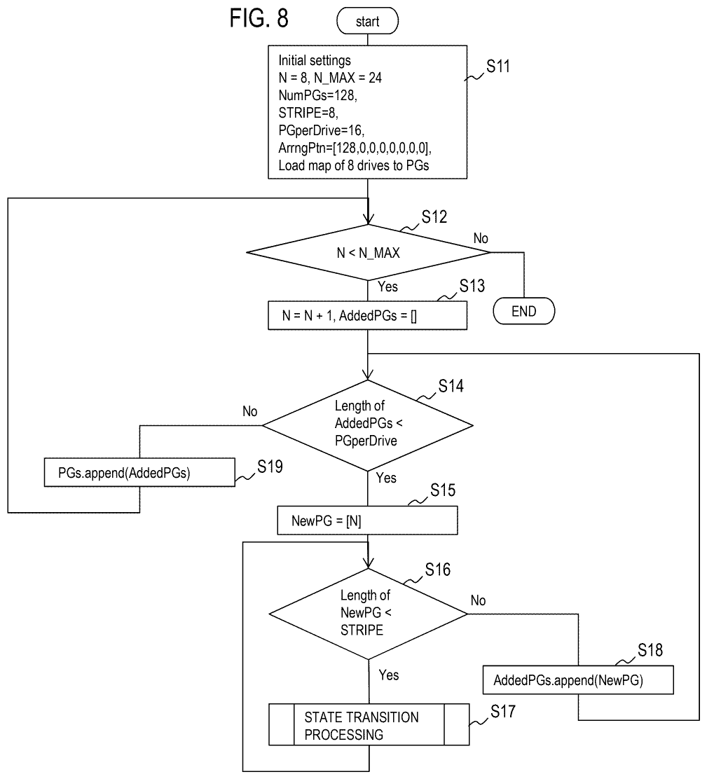

FIG. 8 is a flowchart of integrated map generation processing according to an embodiment. FIG. 8 is an example of the integrated map generation processing when the state transition table 30 is in the state illustrated in FIG. 5 and the transition permission list 31 is in the state illustrated in FIG. 6.

The integrated map generation processing is processing that repeatedly executes processing of generating a map for a total count of (N+1) drives by adding correspondence relations for the new parcel group set 23 that are increased by adding one drive based on a map for a total count of N drives and correcting the correspondence relations.

In the embodiment, a case where 16 parcel groups can be stored in the capacity of one drive 7 and the number of parcels of the parcel group, that is, the stripe width is 8 will be described as an example.

The CPU 12 of the server 11 executes the integrated map generation processing by executing a program for the integrated map generation processing. First, the CPU 12 executes initial processing of setting variables, constants, arrays, and the like (S11). Specifically, the CPU 12 sets 8, which is an initial value, as the drive count (N) indicating the total count of drives, sets 24 as the maximum drive count (N MAX) indicating the maximum total count of drives in the storage system 1, sets 8×16=128 as the all-parcel-group count (NumPGs) indicating the total count of parcel groups in the storage system 1, sets 8 as the stripe width (STRIPE) indicating the count of parcels of the parcel group 22, sets 16 as the parcel group count per drive (PGperDrive) indicating the count of parcel groups that can be stored in one drive, sets [128, 0, 0, 0, 0, 0, 0, 0, 0] as an array (ArrngPtn) indicating the parcel group count for each arrangement pattern (eight arrangement patterns illustrated in FIG. 5) indicating the arrangement of parcels in a parcel group, and sets a map in a case where the drive count is eight for the array PGs. The map in a case where the drive count is eight is created in advance before the integrated map generation processing.

Next, the CPU 12 determines whether the drive count N is smaller than the maximum drive count N_MAX (S12). As a result, when the drive count N is smaller than the maximum drive count N MAX (S12: Yes), this means that maps corresponding to each count up to the maximum drive count are not created, so the CPU 12 executes the processing from step S13. On the other hand, when the drive count N is not smaller than the maximum drive count N MAX (S12: No), the processing of step S13 and subsequent steps is repeatedly executed 16 times in this example until the drive count N reaches the maximum drive count N MAX, meaning that maps (PGs) corresponding to each count up to the maximum drive count are generated, so the CPU 12 ends the processing.

In step S13, the CPU 12 adds 1 to the drive count N, and initializes, as an empty list, an array AddedPGs that holds the arrangement position of each parcel for the new parcel group set 23.

Next, the CPU 12 determines whether the number of elements of the array AddedPGs is smaller than the parcel group count per drive PGperDrive (S14). As a result, when the number of elements of the array AddedPGs is smaller than the parcel group count per drive PGperDrive (S14: Yes), it means that the storage position of each parcel is not determined for all the parcel groups of the added drive 7, and thus the CPU 12 executes the processing from step S15. On the other hand, when the number of elements of the array AddedPGs is not smaller than the parcel group count per drive PGperDrive (S14: No), this means that elements are created for all the added parcel groups, and thus the CPU 12 adds the elements of the array AddedPGs to the array PGs (S19), and advances the processing to step S12.

In step S15, the CPU 12 initializes the array NewPG that holds information on the drive in which each parcel of the new parcel group 22 is arranged. In the embodiment, the CPU 12 determines a first element to be N, and initializes the remaining elements as an empty list. Accordingly, the processing of determining the elements of the array NewPG in and after step S16 can be reduced by one element. Here, a fact that NewPG has N as an element means that one parcel 21 is always arranged in the added N-th drive 7 for the new parcel group 22, and it is not necessary to replace this parcel with parcels in the other drives 7. In step S15, the array NewPG may be initialized as an empty list.

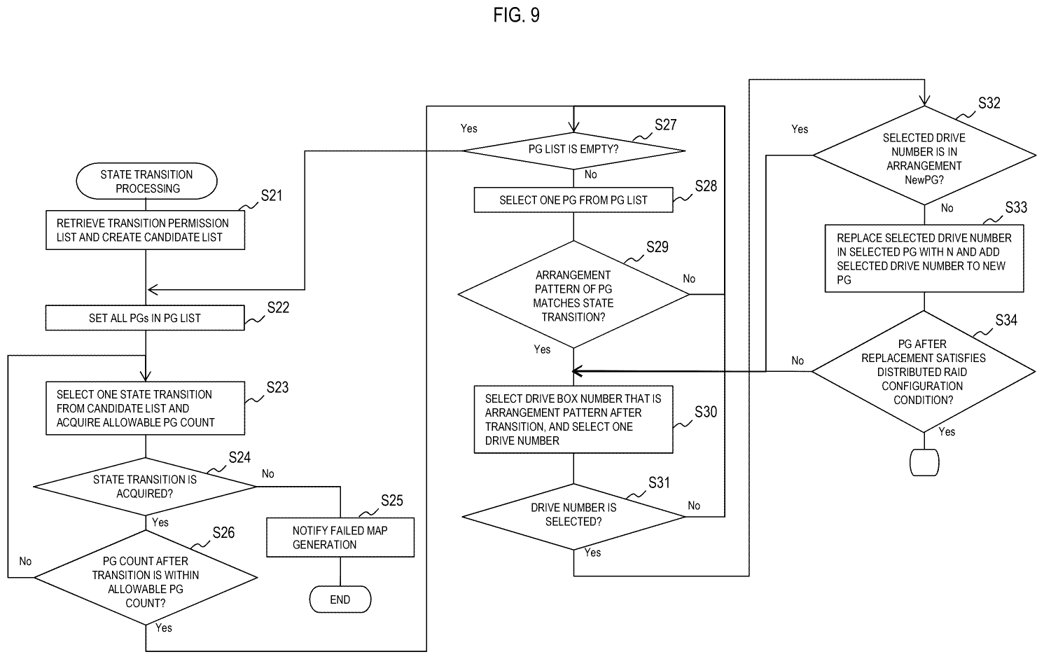

Next, the CPU 12 determines whether the number of elements of the array NewPG is smaller than a stripe width STRIPE (S16). As a result, when the number of elements of the array NewPG is smaller than the stripe width STRIPE (S16: Yes), this means that the arrangement positions for all the parcels of the parcel group are not determined, and thus the CPU 12 executes state transition processing (see FIG. 9) of determining the arrangement positions of the parcels, that is, existing parcels to be replaced with new parcels (S17), and advances the processing to step S16. On the other hand, when the number of elements of the array NewPG is not smaller than the stripe width STRIPE (S16: No), this means that the arrangement positions for all the parcels of the parcel group are determined, so the CPU 12 adds the array NewPG for the new parcel group 22 to the array AddedPGs for the parcel group set 23 (S18), and advances the processing to step S14.

Next, the state transition processing of step S17 will be described.

FIG. 9 is a flowchart of state transition processing according to an embodiment.

The state transition processing is processing of determining the existing parcel 21 that is to be replaced with one new parcel 21, and specifically, processing of determining an arrangement pattern, to which the parcel group 22 to be replaced changes, based on the state transition table 30 and the transition permission list 31 and determining the existing parcel 21 to be replaced within the range of the change.

The CPU 12 searches the transition permission list 31 based on the drive count N, specifies a possible change (state transition) in the arrangement pattern, and creates a candidate list by listing the specified change in the arrangement pattern (S21).

Next, the CPU 12 sets all existing parcel groups 22 in a PG list (S22).

Next, the CPU 12 selects a change in one arrangement pattern from the candidate list, and refers to the state transition table 30 to acquire an allowable parcel group count, which is the number of parcel groups that are allowed as an arrangement pattern after the state transition so as to satisfy the selected change in the arrangement pattern (S23).

Next, the CPU 12 determines whether the change in the arrangement pattern is acquired from the candidate list (S24), and when the change in the arrangement pattern is not acquired (S24: No), the CPU 12 notifies the user of failed map generation (S25), and ends the integrated map generation processing.

On the other hand, when the change in the arrangement pattern is acquired from the candidate list (S24: Yes), the CPU 12 determines whether a parcel group count of the arrangement pattern after the state transition is within the allowable parcel group count (S26).

As a result, when the parcel group count of the arrangement pattern after the state transition is not within the allowable parcel group count (S26: No), it means that the acquired change in the arrangement pattern is not allowed any more, and thus the CPU 12 advances the processing to step S23 and performs the processing for another change in the arrangement pattern of the candidate list.

On the other hand, when the parcel group count of the arrangement pattern after the state transition is within the allowable parcel group count (S26: Yes), the CPU 12 determines whether the PG list is empty (S27). As a result, when the PG list is empty (S27: Yes), it means that there is no target parcel group, and thus the CPU 12 advances the processing to step S22.

On the other hand, when the PG list is not empty (S27: No), the CPU 12 selects one parcel group to be processed from the PG list, for example, randomly selects the parcel group (S28). The CPU 12 deletes the selected parcel group from the PG list. Here, in the description of this processing, the selected parcel group is referred to as a candidate parcel group.

Next, the CPU 12 determines whether an arrangement pattern of the candidate parcel group matches selected state transition (S29). Specifically, when any one parcel in the candidate parcel group is replaced with the parcel of the N-th drive 7, the CPU 12 determines whether the arrangement pattern matches the selected state transition. As a result, when it is determined that the arrangement pattern of the candidate parcel group does not match the selected state transition (S29: No), it means that the parcel of the candidate parcel group is not the parcel to be replaced, and thus the CPU 12 advances the processing to step S27.

On the other hand, when it is determined that the arrangement pattern of the candidate parcel group matches the selected state transition (S29: Yes), the CPU 12 selects a drive box number such that the arrangement pattern after the selected state transition of the arrangement pattern is obtained in the candidate parcel group, and selects one drive number of the drive accommodated in the drive box (S30).

Next, the CPU 12 determines whether the drive number is selected in step S30 (S31). As a result, when the drive number is not selected (S31: No), the CPU 12 advances the processing to step S27.

On the other hand, when the drive number is selected (S31: Yes), the CPU 12 determines whether the selected drive number is present in the array NewPG (S32). As a result, when the selected drive number is present in the array NewPG (S32: Yes), since a plurality of parcels in the parcel group cannot be arranged in the same drive, the CPU 12 advances the processing to step S30 and selects another drive number.

On the other hand, when the selected drive number is not present in the array NewPG (S32: No), the CPU 12 replaces the current drive in the array PGs of parcels that are candidates to be moved to the selected drive in the candidate parcel group with the N-th drive, and adds the selected drive number to the array NewPG of the new parcel group 22 (S33).

Next, the CPU 12 determines whether the candidate parcel group satisfies a configuration condition of the distributed RAID, that is, whether parcels arranged in the same drive number are not present in the same parcel group (S34). As a result, when the configuration condition is satisfied (S34: Yes), the CPU 12 ends the state transition processing and advances the processing to step S16 in FIG. 8.

On the other hand, when the configuration condition is not satisfied (S34: No), the CPU 12 cancels the processing of step S33 and advances the processing to step S30.

The invention is not limited to the above-described embodiment, and can be appropriately modified and implemented without departing from the gist of the invention.

For example, although the server 11 stores the transition permission list 31 in the above-described embodiment, the server 11 may specify the information of the transition permission list 31 from the information of the state transition table 30 without including the transition permission list 31.

Although an example in which the server 11 generates the integrated map 8 is illustrated in the above-described embodiment, the invention is not limited thereto. For example, the storage system 1 may generate the integrated map 8 by processing similar to that of the server 11. In this case, the integrated map 8 may be dynamically generated during the operation of the storage system 1 without being stored in advance in the storage system 1.

What is claimed is:

1. A storage system including a plurality of drive boxes each accommodating one or more drives, wherein
the storage system manages a plurality of parcel groups, each of which includes a parcel including user data and a parcel including redundant data for restoring the user data, in a distributed manner such that parcels included in a same parcel group are not arranged in a same drive,
the storage system includes a storage device that stores a map group including a map showing a correspondence relation between each parcel and a drive storing the parcel, the map group corresponding to a respective count within a predetermined count range of the drive that is able to be installed in the storage system,
a first map corresponding to a first count in a case where the number of drives accommodated in the plurality of drive boxes is same has a drive box failure resistance correspondence relation that is a correspondence relation between the parcel and the drive storing the parcel, the drive box failure resistance correspondence relation having drive box failure resistance by which the user data is not lost even if a failure occurs in drive boxes of a predetermined number or less, and
the first map has a correspondence relation that is able to be implemented by moving data of one parcel in certain parcel groups to a drive box in which a drive is added, from a storage state of the parcel in the drive according to a correspondence relation between the parcel and the drive in a second map corresponding to a second count of the drive less than the first count by one.

2. The storage system according to claim 1, wherein
when adding one drive, the storage system adjusts an arrangement position of the parcel of the parcel group based on a correspondence relation of a map corresponding to a case where one drive is added.

3. The storage system according to claim 1, wherein
the predetermined count range is from a minimum count to a maximum count that is able to be installed in the storage system.

4. The storage system according to claim 1, wherein
the storage system displays a proposal screen for proposing a drive count that needs to be added or reduced from a drive count actually provided to achieve the drive box failure resistance correspondence relation.

5. A map generation device for generating a map showing a correspondence relation between each parcel and a drive storing the parcel in a storage system, the storage system including a plurality of drive boxes each accommodating one or more drives, the storage system managing a plurality of parcel groups, each of which includes a parcel including user data and a parcel including redundant data for restoring the user data, in a distributed manner such that parcels included in a same parcel group are not arranged in a same drive, the map generation device comprising:
a processor, wherein
with respect to a predetermined count range of the drive that is able to be installed in the storage system, the processor generates maps stepwise as the drive is added one by one based on a map corresponding to a minimum count in the count range, thereby generating maps corresponding to respective counts in the count range,
a first map corresponding to a first count in a case where the number of drives accommodated in the plurality of drive boxes is same has a drive box failure resistance correspondence relation that is a correspondence relation between the parcel and the drive storing the parcel, the drive box failure resistance correspondence relation having drive box failure resistance by which the user data is not lost even if a failure occurs in drive boxes of a predetermined number or less, and
the first map has a correspondence relation that is able to be implemented by moving data of one parcel in certain parcel groups to a drive box in which a drive is added, from a storage state of the parcel in the drive according to a correspondence relation between the parcel and the drive in a second map corresponding to a second count of the drive less than the first count by one.

6. The map generation device according to claim 5, further comprising:
a storage device, wherein
the storage device stores a state transition table that stores an arrangement pattern of parcels of a parcel group to drive boxes and a parcel group count in the arrangement pattern, for each count in the predetermined count range of the drive that is able to be installed in the storage system,
in the state transition table, for the first count in a case where the number of drives accommodated in the plurality of drive boxes is the same, the number of all parcel groups is associated with an arrangement pattern in which the same number of parcels of the parcel groups are stored in each drive box,
for a second count of the drive less than the first count by one, the number of a part of the parcel groups is associated with one or more first arrangement patterns in which the same number of parcels of the parcel groups are stored in each drive box by moving one parcel of the parcel groups, and the number of remaining parcel groups is associated with a second arrangement pattern in which the same number of parcels of the parcel groups are stored in each drive box, and
the processor generates the first map corresponding to the first count by adding an area of one drive to the second map corresponding to the second count and adjusting the correspondence relation between the parcel and the drive storing the parcel such that parcel groups corresponding to the second arrangement pattern of the state transition table are in the first arrangement pattern.

7. A map generation method to be executed by a map generation device for generating a map showing a correspondence relation between each parcel and a drive storing the parcel in a storage system, the storage system including a plurality of drive boxes each accommodating one or more drives, the storage system managing a plurality of parcel groups, each of which includes a parcel including user data and a parcel including redundant data for restoring the user data, in a distributed manner such that parcels included in a same parcel group are not arranged in a same drive, wherein
with respect to a predetermined count range of the drive that is able to be installed in the storage system, the map generation device generates maps stepwise as the drive is added one by one based on a map corresponding to a minimum count in the count range, thereby generating maps corresponding to respective counts in the count range,
a first map corresponding to a first count in a case where the number of drives accommodated in the plurality of drive boxes is same has a drive box failure resistance correspondence relation that is a correspondence relation between the parcel and the drive storing the parcel, the drive box failure resistance correspondence relation having drive box failure resistance by which the user data is not lost even if a failure occurs in drive boxes of a predetermined number or less, and
the first map has a correspondence relation that is able to be implemented by moving data of one parcel in certain parcel groups to a drive box in which a drive is added, from a storage state of the parcel in the drive according to a correspondence relation between the parcel and the drive in a second map corresponding to a second count of the drive less than the first count by one.
